(19) United States
(12) Patent Application Publication
(10) Pub. No.: US 2006/0212816 A1
(43) Pub. Date: Sep. 21, 2006

(54) Accessibility enhanced user interface

(75) Inventor: Oskari Koskimies, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/084,439

(22) Filed: Mar. 17, 2005

(51) Int. Cl. G06F 3/00

(52) U.S. Cl. 715/744

(57) ABSTRACT

Selecting a user desired hyperlink is provided by dividing displayed content into two or more parts and letting a user to choose from the parts the one that contains a desired link. If the part contains no other links, that link is launched, otherwise the chosen part is repeatedly divided on user choice until the desired link is uniquely identified and can be launched so as to provide an accessibility enhanced user interface particularly for miniature devices and for handicapped users. The dividing of the content into parts is illustrated based drawing respective regions or by highlighting differently links associated with different parts. The selection of the desired part is carried out with suitable one or more keys or with voice recognition.

### FIELD OF THE INVENTION

This invention relates to accessibility enhanced user interfaces and is particularly, but not necessarily, related to accessibility enhanced user interfaces for portable devices such as mobile telephones.

### BACKGROUND OF THE INVENTION

Various electronic devices contain a display for presenting different content and some keys to input user commands and text. Typically, the commonly used functions and texts are mapped such that given keys correspond to given functions and there is a one-to-one relationship between the content and keys. Present basic menus and displays of mobile telephones exemplify this approach. In some occasions, however, it is not possible to provide any predetermined one-to-one correspondence between the content and user keys. Browsing the Internet or generally using interactive content or content comprising hyperlinks involves laying out the content as defined by the content, not the device. If the user obtains an arbitrary content with hyperlinks, the pointers to such links fall into arbitrary parts of the display. To enable selecting a given link, the user typically moves a cursor with a pointing device such as a two- or four-way key. Touch screens enable very intuitive access to display contents, although at relatively high expense, somewhat inaccurate response, low contrast and high exposure to dirt and scratches. Yet the user interface should be extremely simplified when required by the environment under which the user interface operates or particular user based preferences. For instance, sense defects and other handicaps may severely impair or even inhibit the use of small buttons.

There are simultaneous self-conflicting tendencies of increasing sizes of displays and reducing overall size and weight of portable devices such as mobile telephones. Coupled to the need to access interactive content, it is clear that new alternative methods are highly appreciated.

### SUMMARY OF THE INVENTION

According to a first aspect of the invention there is provided a user interface comprising:

a display capable of presenting interactive content, comprising a user desired access portion, configured to present the content in at least two user distinguishable parts; and

an input for reading user commands configured to select one of the parts to identify the part containing the user desired access portion.

It is an advantage of the invention that the user may identify any access portion such as a hyper link or command button from within the content by selecting the part of the content which contains the user desired access portion. Preferably, the user desired access portion is also selected for further processing when it is uniquely identified. The unique identification may take place by determining that no other possible access portions reside in the selected part.

Preferably, in case that the selected part comprises more than one access portion, the display is configured to present the user selected part in at least two subparts and the input is configured to identify the subpart comprising the user desired access portion. Advantageously, by further dividing the selected part into subparts and selecting a corresponding subpart, the user desired access portion is narrowed down to a smaller proportion of the presented content. When the selected subpart contains only one access portion, the user interface may indicate the remaining access portion as the user desired access portion.

Preferably, the content is user selectable content. It is particularly useful to provide the present invention in connection with user selectable content where typically no association between user interface input and access portions of the content can be predetermined. Instead, the user may be free to choose any available content or even create the content.

Preferably, the selected part or sub-part need not entirely contain the desired access portion. The desired access portion may extend beyond the selected one part or sub-part and the desired access portion may span between two different the parts or sub-parts.

Preferably, the input comprises at least two input devices, such as separate keys or use parts of a common key or pointing device, using which the user may perform the selecting of the one part. Providing two separate keys provides for an easy and quick selection process. Equally, a joystick type of pointing stick or rocker switch can be used. Alternatively, the input may employ one key to identify a first part and in the absence of the actuation of the key for a given period of time, a second part is determined as selected. Further alternatively, the one key may alternately be associated with different parts so that each part in turns is highlighted and the user selects the desired part by using the key when the desired part is highlighted.

Further alternatively, the input may employ one key so that as long as the user keeps on pressing the key either continuously or repeatedly with a frequency above a threshold limit, the selected part changes and becomes highlighted and after the user no longer uses the key for a given time, the presently highlighted part remains as selected. In one advantageous alternative, the content is presented in three or more parts one of which is highlighted and the highlight is moved by employing the one key.

Alternative to time-based selection of the part, a second key may be used to confirm the selection of the part containing the user desired access portion.

The input and display may be configured to divide the content into the at least two parts so that each part contains approximately similar amount of access portions. The content may also be divided into at least two regions such that each region forms one part and may contain a number of access portions or so that alternating access portions belong to different parts. For instance, alternating one access portion out of two or more access portions may be highlighted and correspond to a key when highlighted or that statically corresponds to the highlighted keys. The colour displays enable simple and intuitive distinguishing of the different access portions into different parts by using different text colour, underline colour, shading or shading colour, for example.

According to a second aspect of the invention, a mobile telephone is provided comprising a user interface according to the first aspect of the invention.

According to a third aspect of the invention, controller for device comprising a display and an input, provided with means for controlling the display and the input to operate in accordance with the first aspect of the invention.

According to a fourth aspect of the invention, there is provided a method for controlling a device comprising a display and an input for user commands, comprising:

presenting on a display interactive content, comprising a user desired access portion, in at least two user distinguishable parts; and

reading user commands configured to select one of the parts in order to identify the part containing the user desired access portion.

According to a fifth aspect of the invention, a computer program for controlling a device is provided comprising computer executable program code configured to cause the device to operate according to the fourth aspect of the present invention.

According to a sixth aspect of the invention, a computer program product stored on a memory medium is provided comprising computer program code according to the fifth aspect of the present invention.

The device is preferably a mobile device, even more preferably a portable device. Such devices benefit from the invention as the mobility typically restricts the size and amount of the user interface parts so that accessing the access portions otherwise may appear difficult.

The embodiments of one aspect may also apply to various other aspects of the invention. In sake of briefness, the embodiments have not been repeated in connection with every aspect of the invention. A skilled reader will appreciate the advantages of the various aspects based on the advantages of any aspect of the invention.

### BRIEF DESCRIPTION OF THE DRAWINGS

The invention will now be described, by way of example only, with reference to the accompanying drawings, in which:

FIG. 1 shows a block diagram of a mobile telephone according to a preferred embodiment of the invention;

FIGS. 2 to 5 illustrate the display of the mobile telephone of FIG. 1 in course of selecting a link in content presented on the display;

FIGS. 6 and 7 show a flow chart illustrating the operation of the mobile telephone in selecting the link according to FIGS. 2 to 5;

FIGS. 8 to 11 show a set of displays illustrating the highlighting of given sets of hyperlinks so as to narrow down and identify the desired link; and

FIG. 12 shows using different highlights around different links to facilitate the selection of a desired link.

### DETAILED DESCRIPTION

In the following, an embodiment of the invention will be described applied to a mobile telephone for the Global System for Mobile Communications (GSM) telecommunications network. Whilst the invention is particularly useful in connection with modern mobile telephones, it may also be used in various entertainment devices such as portable or fixed gaming stations, Personal Digital Assistants (PDA), television sets, set top boxes for televisions and tablet PCs, generally anywhere that interactive content without predetermined association of links or other access portions exists with keys or other user input equipment. A link and an access portion generally refer to hyperlinks and other parts of the displayed content that can serve to provide access to given information, action or service. For instance, an executable application, macro or command may be linked to an access portion in a document so that this access portion can be used to launch the application or macro, generally referred to as executable data.

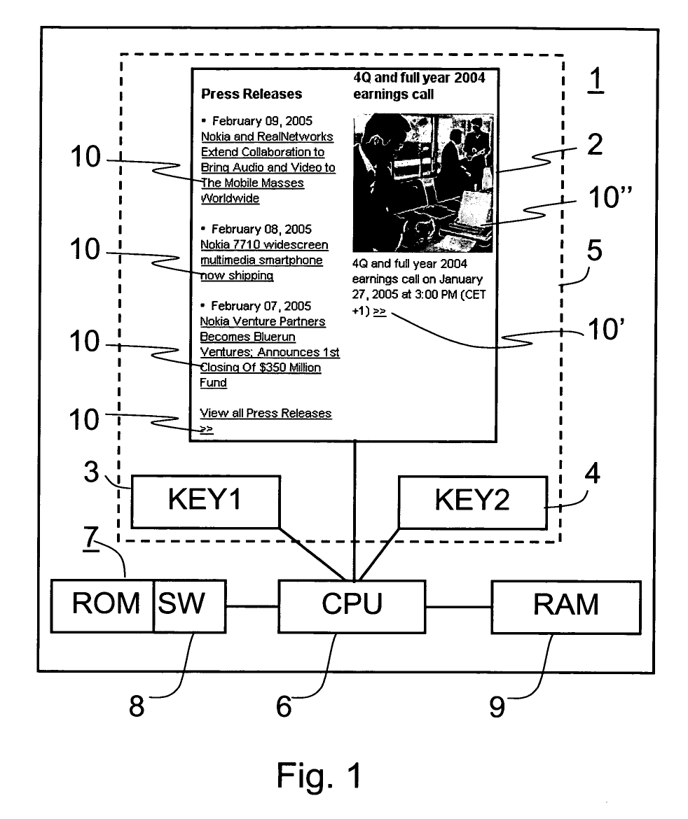

FIG. 1 shows a block diagram of a mobile telephone 1 according to an embodiment of the invention. The mobile telephone 1 or phone in short comprises user interface 5 that contains a display 2 for displaying interactive content (typically containing hyperlinks 10) and two keys 3 and 4 for selecting hyperlinks 10, 10′, 10″ or other access portions in interactive content. The phone 1 further comprises processing equipment 6 to 9 for controlling the operation of the phone 1. The phone 1 also contains normal circuitry for performing the normal operation of a cellular phone.

The processing circuitry comprises a processor 6 that may be a Master Control Unit (MCU) of the phone 1 or a dedicated or shared other processor such as a microprocessor (e.g. a Central Processing Unit CPU) or Digital Signal Processor (DSP). The processor generally acts as a controller controlling the operation of the user interface 5. Non-volatile or long-lasting memory 7 contains operation instructions 8, that is software, according to which the processor 6 operates. Under normal operation, the processor typically loads to the operation instructions 8 from the long-lasting memory 7 to a work memory 9 that is typically of Random Access Memory (RAM) type. Alternatively, the process may execute the operation instructions directly within the long-lasting memory.

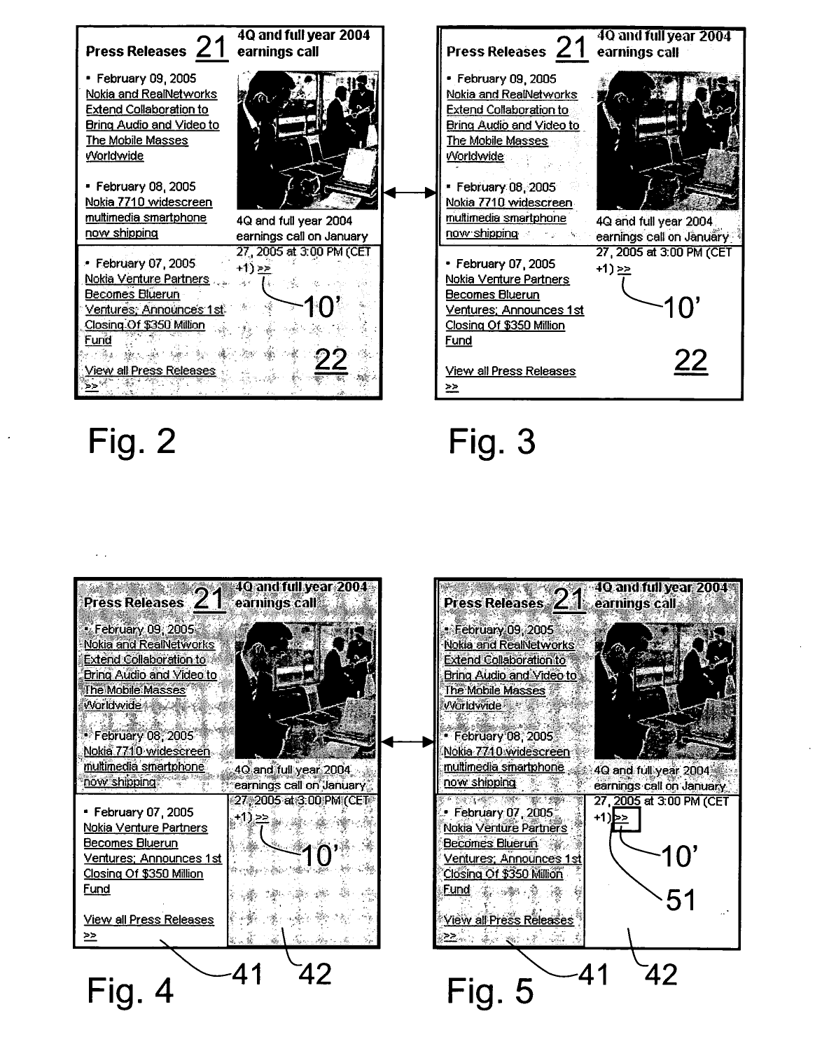

FIGS. 2 to 5 illustrate the display of the mobile telephone of FIG. 1 in course of selecting a link in content presented on the display. Let us assume that the user wishes to see an interim report of link 10′ in FIG. 1. The content on display 2 is first horizontally split roughly in half so that an upper part or first part 21 of the content contains two hyperlinks and one image (that is three access portions) and a lower part or second part 22 of the content contains three links. Either the first or second part is highlighted at the time; the other part is indicated in a user perceivable manner such as dimmer colour or shade or blinking. The highlighted part may also contain a rim to indicate its highlight or selection. Using the first key 3 the user may alternate the highlighted part until a desired part is selected. Using the second key 4 confirms the selection of the desired part. Additionally, or alternatively, the links or access portions of the first part 21 and of the second part 22 are highlighted in user perceivably different manner so that it is clear which links are associated with each part. As the desired access portion (link 10′) was in the second part 22, the second part is next split into two subparts, a first subpart 41 and a second subpart 42 as shown in FIGS. 4 and 5. FIG. 5 shows also a special highlighting, box 51 around the uniquely identified access portion 10′ when highlighted. This special highlighting indicates the user that confirming the second subpart will readily confirm that access portion as the desired access portion and invoke corresponding action. In this case, the access portion being a link, the action would be opening a new WWW page as indicated by the link.

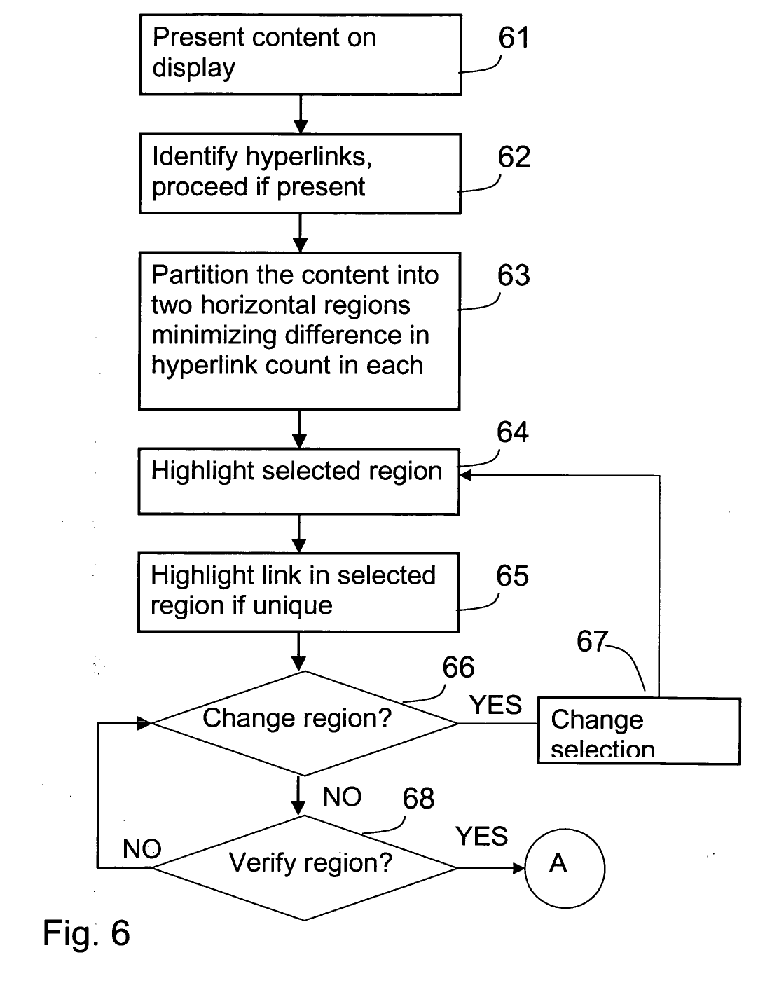

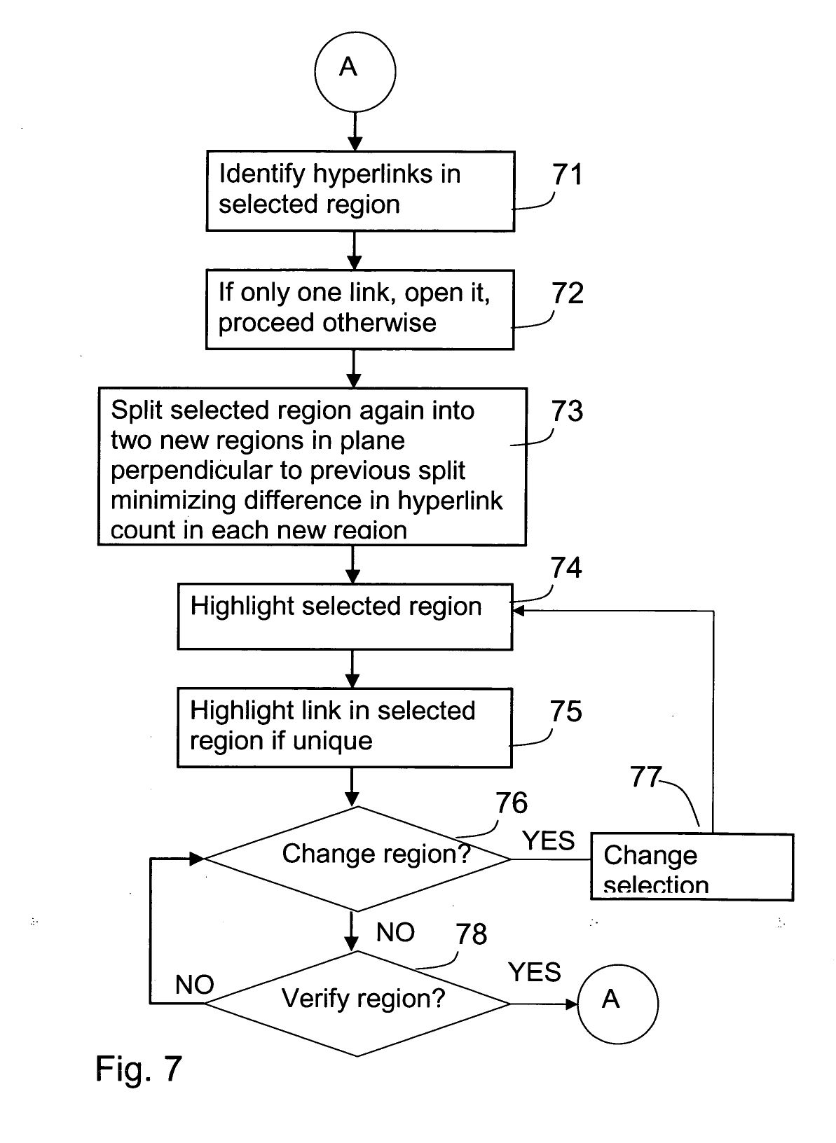

FIGS. 6 and 7 shows a flow chart illustrating the operation of the mobile telephone in selecting the link according to FIGS. 2 to 5. First, in step 61 some content such as an xml-based document or html-based Internet page or its part is displayed on the display 2. The content is parsed and presented as is known from the art. Next, hyperlinks or different access portions within the content are identified 62. If no hyperlinks are found, there is no need to select one but otherwise the process continues in step 63 where the content is partitioned of split into two horizontal regions so that each has roughly the same amount of links and the sizes of the regions appear similar. One of these regions, here the top region or first part, is highlighted 64 by turning dim the remaining region or second part. If only one link is present in the selected region, then this link is highlighted 65 to demonstrate that the user may now launch the hyperlink. Next, it is checked 66 if the user desires to change the region. If yes, the selection is changed 67, otherwise it is checked 68 if the region is verified. By verifying a region, that region is selected for further narrowing down to the desired access portion or starting an action associated with the desired access portion if uniquely identified by the verification. If the result of checking 68 is negative, the process returns to step 66, otherwise it proceeds to step 71 in FIG. 7, where hyperlinks in the selected region are identified. Next, it is checked if only one link existed in the selected region and if yes, that link is opened 72, otherwise the process goes on. The selected region is next split 73 or divided again into two regions. If the first and second part were divided horizontally, next dividing is preferably made vertically and vice versa, in order to narrow down the regions with an easy to perceive shapes. Preferably, it is tested which way (horizontal or vertical) first dividing results in more balanced dividing of the access portions into the two regions. It is also possible to divide a region in the same direction as previously (for instance, divide a horizontally divided region horizontally again). The division is advantageously made such that the number of links in each region is balanced possibly simultaneously trying to split the regions into two roughly similar sized bands. One of these new regions or subparts is initially selected and the selected region is highlighted 74. If only one link exists in the region, then that link is highlighted 75. It is next checked 76 whether the user desires to change the region and if yes, the selection is changed 77 and the process returns to step 74 (highlighting the selected region). Otherwise, it is checked 78 if the user has verified the region, that is, used the second key 4 to show that the desired link resides in that region. If yes, the operation loops back to step 71, where it is again checked if a link is now uniquely identified and in such a case opened.

It should be appreciated that the details of the above description may be freely adapted. For instance, the number of regions may be more than two, such as three or four and also depending on the number of links, only fewer or more numerous regions may be presented. Also the regions need not be indicated by dimming the remaining part of display: the links of selected region may be specially highlighted compared to remaining links, as is shown with reference to FIGS. 8 to 1. Moreover, the second key 4 may also be dispensed with by use of a timer. For instance, a double click on key 3 may be interpreted as a confirmation or the selection may be cycled through the regions until stopping the changing of the region is interpreted as confirmation of the presently selected region. Further, the region may also automatically change with a given interval of time so that using key 3 confirms the presently selected region.

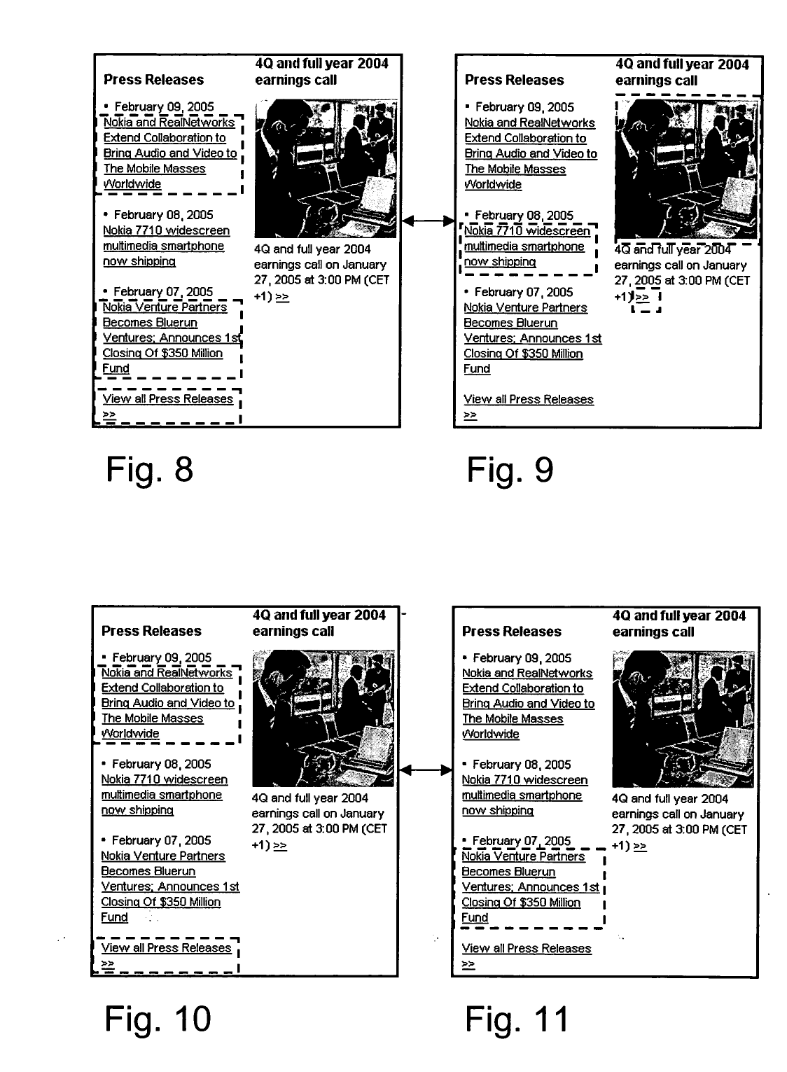

FIGS. 8 to 11 show a set of displays illustrating the highlighting of given sets of hyperlinks so as to narrow down and identify the desired link. The links or access portions can be highlighted in an alternating fashion such that desired share of the access portions are highlighted with a regular frequency on the display. Alternatively, instead of geometric grouping the access portions can be grouped partly or entirely based on the order in which respective tokens appear in the content such as HyperText Mark-up Language source data (HTML) or eXtensible Mark up Language (XML) in general. FIG. 10 illustrates a sample display where the content comprises a set of access portions and every second access portion of the source data is supposed to be highlighted. A user can alternate between the states shown by FIG. 10 and FIG. 11 to choose the set of access portions that contains the desired access portion. FIG. 10 illustrates the case wherein one half of access portions are first verified and the remaining three links are divided to two links (in FIG. 10) and one link (in FIG. 11). If the user verifies the case of FIG. 11, then the link illustrated there is launched or the document pointed by that link is presented to the user.

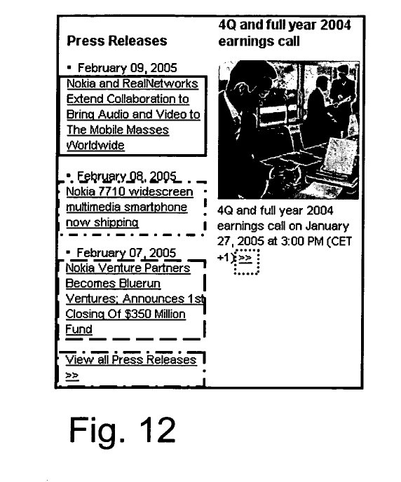

FIG. 12 shows a further alternative which can be used instead or in addition to the foregoing techniques. Whereas FIGS. 8 to 11 effectively provided two types of presentation for the access portions (highlighted or not), FIG. 12 illustrates a plurality of different presentation formats for the access portions so three or more (sometimes all) of the access portions are uniquely presented. The user then identifies the desired access portion by identifying it with its presentation format. This can advantageously take place by speech recognition so that the user names the presentation format associated with the desired access portion. The presentation formats can be, as in FIG. 14, different dashed lines, or double lines, dimmed or brightened portions, different fonts and different colours may be used for the content in the access portion or for a frame of the access portion. Where colours are used, it is possible to access a desired access portion hands-free by saying its name such as “blue”.
In the embodiments where the content is presented in different regions, each of the regions advantageously contains substantially similar number of links. Alternatively or additionally, the regions conform when possible to the visible boundaries in the content such as columns and paragraphs. Further, both in the region based and individual access portion highlighting approach, the division can be based on the type of links such that advantageously text links, file links and images, for example, fall into respective parts.
alternating group for every second access portion
   The mobile telephone 1 alternates the highlight between the first part 21 and the second part 22 so that they are highlighted in turns for a given interval such as 1 to 10 seconds.

In case of region based access portion selection, it may happen that some links bridge two regions. Then, the user may simply indicate whether the desired region contains any part of the desired link, and as long as the number of split links is not too big every choice narrows down the number of possible links. Alternatively, each access portion may belong to only one region (for example, the first possible one in the direction of normal reading in the human language used by the user). However, to make it clear to the user which links belong to the currently selected region, the highlighting is advantageous to use.

There are also various different ways to distinguish or highlight access portions which can be employed alone or in combination, such as:
Highlighting links (different background colour)
Outline links (variation of above)
Highlight for text links, outline for image links
Highlighting area (different background colour)
Outline area
Dimming
Blinking (links or area)
The highlighting can be implemented using a capability of an application used to display the content and/or by a browser plug-in or even JavaScript which included by the content such as an HTML page.
It may also be desirable to temporarily change the colour scheme of the page to facilitate selection (for example, to force certain background colour and text colour to ensure that link highlights are visible and will not drown out the link text)
It is also advantageous to enable undoing verifying a part of the content. If only one key is used, a long period of inactivity can be detected as a user command to undo the previous verifying. Even more preferably, the long inactivity can enable the user to begin a selection process entirely from the start instead of reversing only the last selection. When the long period of inactivity signals an error situation, the user can be allowed to select at least one of the following options:
   Reversing last selection
   Beginning selection process again from beginning
   Aborting selection process (continue reading page)
   Continuing the selection process (in case of accidental long delay)

In case that two keys are used in the selection process, the keeping of a selection-changing switch pressed for a long period can be used to signal the undo or need to select at least one of the options described in the foregoing paragraph.

In case that three keys are used in the selection process, a separate “reverse selection” switch is advantageous to provide for aborting the selection process if kept pressed for a long time.

The long period of time mentioned in the foregoing advantageously refers to a period which the user normally would not wait but which is not excessive to wait either. It is typically defined by a threshold period exceeding which is determined as the long period. The threshold period can be 1 to 10 or 1 to 20 seconds and it can also depend on the amount of information provided in the content so that the user has sufficient time to perceive the content and its access portions in sufficient extend within the threshold period.

For verifying a region or a set of access portions for next step (for example, for narrowing the region or set or launching a link), any one of the following can be used:
One key: a final step where the selected link is indicated and a user either presses switch or not. If not, corresponding options are provided as in undoing a partition selection.
Two keys: Advantageously, one key cancels an action and the other key confirms the action. However, this suddenly changes the functionality of the other switch which usually used to toggle between choices and may appear counter-intuitive. Alternatively, the user can be provided, using one switch to change between options and other switch to confirm option selection, with selection of:
   Opening the link (accessing the desired access portion)
   Reversing last selection or action
   Beginning the selection process again from start
   Aborting the selection process
Three keys: A separate “reverse selection” key can be used if an undesired link was selected. In this case the key used to switch between selections has no functionality (since there is only one “selection”, the selected link).

The input of the user interface typically contains one or more keys and/or speech recognition means (suitable hardware and software stored in memory). If speech recognition and/or speech synthesis is used, the following words or phrases can be used: Recognize words “yes”, “no”, “back”, “cancel” and the application such as browser asks for each section, “Is the desired link in this section”. The user answers “yes” or “no” and may also answer “back” to reverse last selection or “cancel” to abort selection process. Alternatively, numbers can be used in speech recognition or with a numeric keypad. The screen or access portions will be then divided into a plurality of regions or individual access portions each denoted by respective number. The user speaks or uses a key with the number representing the desired region or access portion to select the part.

Particular implementations and embodiments of the invention have been described. It is clear to a person ordinarily skilled in the art that the invention is not restricted to details of the embodiments presented above, but that it can be implemented in other embodiments using equivalent means without deviating from the characteristics of the invention. Hence, the scope of the invention is only restricted by the attached patent claims.

1. A user interface comprising:
a display capable of presenting interactive content comprising a user desired access portion configured to present the content in at least two user distinguishable parts; and
an input for reading user commands configured to allow the user to select one of the parts in order to identify the part containing the user desired access portion.

2. A user interface according to claim 1, wherein the content is user selectable content.

3. A user interface according to claim 1, wherein the user desired access portion is selected for further processing when it is uniquely identified.

4. A user interface according to claim 1, whereby, in case that the selected part comprises more than one access portion, the display is configured to present the user selected part in at least two subparts and the input is configured to identify the subpart comprising the user desired access portion.

5. A user interface according to claim 1, wherein the user interface is configured to indicate the remaining access portion as the user desired access portion if the selected subpart contains only one access portion.

6. A user interface according to claim 1, wherein the input comprises at least two input devices such as keys for the selecting of the one part.

7. A user interface according to claim 1, wherein the input and the display are configured to divide the content into the at least two parts so that each part contains substantially similar amount of access portions.

8. A user interface according to claim 1, wherein the display is configured to divide the content into at least two regions such that each region forms one part and may contain a number of access portions or so that alternating access portions belong to different parts.

9. A user interface according to claim 1, wherein the user interface device forms part of one of the following: a mobile device, a portable device, a gaming device, a television device, a navigation device and a mobile telephone.

10. A controller for a device with a display and an input for controlling the display and the input, comprising:
means for causing the display to present interactive content, comprising a user desired access portion, in at least two user distinguishable parts; and
means for causing the input to read user commands to select one of the parts in order to identify the part containing the user desired access portion.

11. A controller according to claim 10, wherein the content is user selectable content.

12. A controller according to claim 10, wherein the user desired access portion is also selected for further processing when it is uniquely identified.

13. A controller according to claim 10, further comprising means for configuring the display and the input so that, in case that the selected part comprises more than one access portion, the user selected part is presented in at least two subparts and the input identifies the subpart comprising the user desired access portion.

14. A controller according to claim 10, further comprising means for configuring the user interface to indicate the remaining access portion as the user desired access portion if the selected subpart contains only one access portion.

15. A controller according to claim 10, further comprising means for configuring the input and display to divide the content into the at least two parts so that each part contains approximately similar amount of access portions.

16. A controller according to claim 10, further comprising means for configuring the display to divide the content into at least two regions such that each region forms one part and may contain a number of access portions or so that alternating access portions belong to different parts.

17. A method for controlling a device comprising a display and an input, comprising:
presenting on the display interactive content, comprising a user desired access portion, in at least two user distinguishable parts; and
reading user commands with the input to select one of the parts in order to identify the part containing the user desired access portion.

18. A computer program product stored on a memory medium for controlling a device with a display and an input for controlling the display and the input, comprising:
computer executable program code for causing the display to present interactive content, comprising a user desired access portion, in at least two user distinguishable parts; and
computer executable program code for causing the input to read user commands to select one of the parts in order to identify the part containing the user desired access portion.

19. A computer program product according to claim 18, further comprising computer executable code for configuring the display and the input so that, in case that the selected part comprises more than one access portion, the user selected part is presented in at least two subparts and the input identifies the subpart comprising the user desired access portion.

20. A computer program product according to claim 18, further comprising computer executable code for configuring the display to divide the content such that alternating access portions belong to different one of the first part and the second part.
